(19) United States
(12) Patent Application Publication
(10) Pub. No.: US 2008/0301751 A1
(43) Pub. Date: Dec. 4, 2008

(54) Receiver

(75) Inventor: Tadahiro NAITO, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/125,561

(22) Filed: May 22, 2008

(30) Foreign Application Priority Data
May 28, 2007 (JP) 2007-140090

(51) Int. Cl. H04N 7/16

(52) U.S. Cl. 725/139

(57) ABSTRACT

This receiver includes a first storage portion storing program data allowing the user to watch a television broadcast, a second storage portion storing an operating history of a receiver body including at least a television program watch history, and a control portion updating the program data on the basis of the operating history stored in the second storage portion.

### BACKGROUND OF THE INVENTION

1. Field of the Invention

The present invention relates to a receiver, and more particularly, it relates to a receiver updating program data.

2. Description of the Background Art

A receiver updating program data is known in general, as disclosed in each of Japanese Patent Laying-Open Nos. 2006-197197 and 2006-60345 and National Patent Republication Gazette No. WO2005/001688.

The aforementioned Japanese Patent Laying-Open No. 2006-197197 describes a digital broadcast receiver so formed as to start initialization (updating of program data) after a power source for the receiver is switched to an OFF-state.

The aforementioned Japanese Patent Laying-Open No. 2006-60345 describes a signal receiver so formed as to display a selection screen allowing the user to select whether or not to update software when a power source is brought into an ON-state, so that the user updates the software on this selection screen. Further, the signal receiver is so formed as to automatically update the software when the user does not select whether or not to update the software for a prescribed time.

The aforementioned National Patent Republication Gazette No. WO2005/001688 describes a Java® applet updater (receiver) so formed as to start downloading the latest Java® applet determining that a Java® applet in the updater is not used when the latest Java® applet is uploaded.

However, the digital broadcast receiver according to the aforementioned Japanese Patent Laying-Open No. 2006-197197 starts the initialization after the power source is switched to the OFF-state. Therefore, the digital broadcast receiver can start the initialization in a state not used by the user, while an operation of the user is limited until the digital broadcast receiver terminates the initialization if the user switches the power source to an ON-state after the digital broadcast starts the initialization. Thus, the user is disadvantageously burdened in this case. Further, the digital broadcast receiver may stop the initialization in an intermediate stage depending on the operation of the user, and cannot normally complete the initialization at a result. Therefore, it may not be possible for this digital broadcast receiver to perform the initialization without burdening the user.

The signal receiver according to the aforementioned Japanese Patent Laying-Open No. 2006-60345 requires the user to select updating from the selection screen in order to update the software, to disadvantageously burden the user. When the user does not select whether or not to update the software for the prescribed time, further, the signal receiver automatically updates the software. Therefore, the signal receiver may start updating the software against the user's intention, and the operation of the user is limited until the signal receiver terminates the operation of updating the software in this case, to disadvantageously burden the user. Thus, it may not be possible for this signal receiver to update the software without burdening the user.

The Java® applet updater according to the aforementioned National Patent Republication Gazette No. WO2005/001688 starts downloading the latest Java® applet after determining that the Java® applet in the updater is not used. Therefore, the Java® applet updater can start downloading the latest Java® applet in a state where the user does not use the Java® applet, while an operation of the user is limited until the Java® applet updater terminates the downloading operation if the user starts using the Java® applet after the Java® applet updater starts downloading the latest Java® applet. Thus, the user is disadvantageously burdened in this case. Therefore, it may not be possible for the Java® applet updater to download the latest Java® applet without burdening the user.

### SUMMARY OF THE INVENTION

The present invention has been proposed in order to solve the aforementioned problems, and an object of the present invention is to provide a receiver capable of updating program data while hardly burdening the user.

A receiver according to an aspect of the present invention comprises a receiving portion capable of receiving a television broadcast, a first storage portion storing program data allowing the user to watch the television broadcast, a second storage portion for storing an operating history of a receiver body including at least a television program watch history, and a control portion controlling the receiver body on the basis of the program data and updating the program data on the basis of the operating history stored in the second storage portion.

As hereinabove described, the receiver according to this aspect is provided with the first storage portion storing the program data, the second storage portion for storing the operating history of the receiver body and the control portion updating the program data on the basis of the operating history stored in the second storage portion to be capable of selecting the time when the user less frequently uses the receiver for updating the program data in this period on the basis of the operating history. Therefore, the control portion can update the program data when there is a small possibility that the user uses the receiver. Thus, the possibility that the user starts using the receiver after the control portion starts updating the program data can be reduced, thereby reducing the possibility of limiting an operation of the user and the possibility of stopping the operation of the control portion updating the program data in an intermediate stage due to the operation of the user. Consequently, the control portion can update the program data while hardly burdening the user.

The receiver according to the aforementioned aspect preferably further comprises a third storage portion recording the television broadcast, and the operating history preferably further includes a television program recording reservation history. According to this structure, the control portion can select the time when the user less frequently uses the receiver for updating the program data in this period on the basis of not only the television program watch history but also the television program recording reservation history, whereby the possibility that the user starts using the receiver after the control portion starts updating the program data can be further reduced.

In this case, the control portion is preferably so formed as to update the program data also on the basis of the current television program recording reservation situation along with the operating history. According to this structure, the control portion can select the time when no television program recording is reserved for updating the program data in this period, not to erase television program recording reservation by updating the program data.

In the receiver according to the aforementioned aspect, the control portion is preferably so formed as to control the second storage portion to store the operating history every prescribed time zone. According to this structure, the control portion can update the program data in the time zone when the user less frequently uses the receiver on the basis of the operating history every prescribed time zone.

In this case, the operating history stored in the second storage portion preferably includes an operating history in a first time zone and an operating history in a second time zone exhibiting a lower operating frequency than the first time zone, and the control portion is preferably so formed as to update the program data in the second time zone exhibiting a lower operating frequency than the first time zone. According to this structure, the control portion updates the program data when there is a smaller possibility that the user uses the receiver, whereby the possibility that the user starts using the receiver after the control portion starts updating the program data can be reduced. Thus, a burden on the user can be reduced.

In the receiver according to the aforementioned aspect, the control portion is preferably so formed as to update the program data when the operating frequency is at the lowest level on the basis of the operating history. According to this structure, the control portion updates the program data when there is the smallest possibility that the user uses the receiver, whereby the possibility that the user starts using the receiver after the control portion starts updating the program data can be minimized. Thus, the burden on the user can be minimized.

In the aforementioned structure with the operating history including the operating history in the first time zone and the operating history in the second time zone, the control portion is preferably so formed as to control the receiving portion to receive update data for updating the program data in the second time zone exhibiting a lower operating frequency than the first time zone. According to this structure, the receiving portion receives the update data when there is a lower possibility that the user uses the receiver, whereby the possibility that the user starts using the receiver while the receiving portion receives the update data can be reduced. Thus, the burden on the user can be further reduced.

In the aforementioned structure having the second storage portion storing the operating history every prescribed time zone, the prescribed time zone is preferably divided at a regular interval. According to this structure, operating frequencies in different time zones can be easily compared with each other.

In the receiver according to the aforementioned aspect, the receiving portion is preferably enabled to receive at least either a signal from the Internet or a signal from an external apparatus in addition to a television broadcast signal, and the control portion is preferably so formed as to control the second storage portion to store the operating history of the receiver body including an image watch history based on at least the signal from the Internet or the signal from the external apparatus. According to this structure, the control portion can update the program data on the basis of the operating history including the image watch history based on at least the signal from the Internet or the signal from the external apparatus in addition to the television program watch history, whereby the possibility that the user starts using the receiver while the control portion updates the program data can be further reduced.

In the receiver according to the aforementioned aspect, the control portion is preferably so formed as to control the second storage portion to store the operating history of the receiver body as the television program watch history when the user watches a television program for at least a prescribed time. According to this structure, the control portion can prevent the second storage portion from storing an operation such as selection of a channel performed when the user watches a television program for an extremely short time as a watch history, thereby controlling the second storage portion to store a watch history more conforming to the actual situation.

In the receiver according to the aforementioned aspect, the control portion is preferably so formed as to determine whether or not the receiver body is in a standby state for updating the program data on the basis of the operating history when determining that the receiver body is in the standby state. According to this structure, the control portion updates the program data on the basis of the state of the receiver body at the time of starting updating the program data in addition to the operating history of the receiver body, whereby the burden on the user can be further reduced.

In the receiver according to the aforementioned aspect, the television program watch history is preferably an accumulative watch history from the time of purchase of the receiver. According to this structure, the control portion can update the program data on the basis of the operating history including a larger number of watch histories.

In the receiver according to the aforementioned aspect, the receiver is preferably a television set. According to this structure, a television set capable of updating program data while hardly burdening the user can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram for illustrating the structure of a television set according to an embodiment of the present invention;

FIG. 2 illustrates exemplary operating frequency measurement data in the television set according to the embodiment of the present invention shown in FIG. 1;

FIG. 3 is a flow chart for illustrating an operating frequency measurement data update operation in the television set according to the embodiment of the present invention shown in FIG. 1;

FIG. 4 is a flow chart for illustrating a firmware update data receiving operation in the television set according to the embodiment of the present invention shown in FIG. 1; and

FIG. 5 is a flow chart for illustrating a firmware update operation in the television set according to the embodiment of the present invention shown in FIG. 1.

### DESCRIPTION OF THE PREFERRED EMBODIMENTS

An embodiment of the present invention is now described with reference to the accompanying drawings.

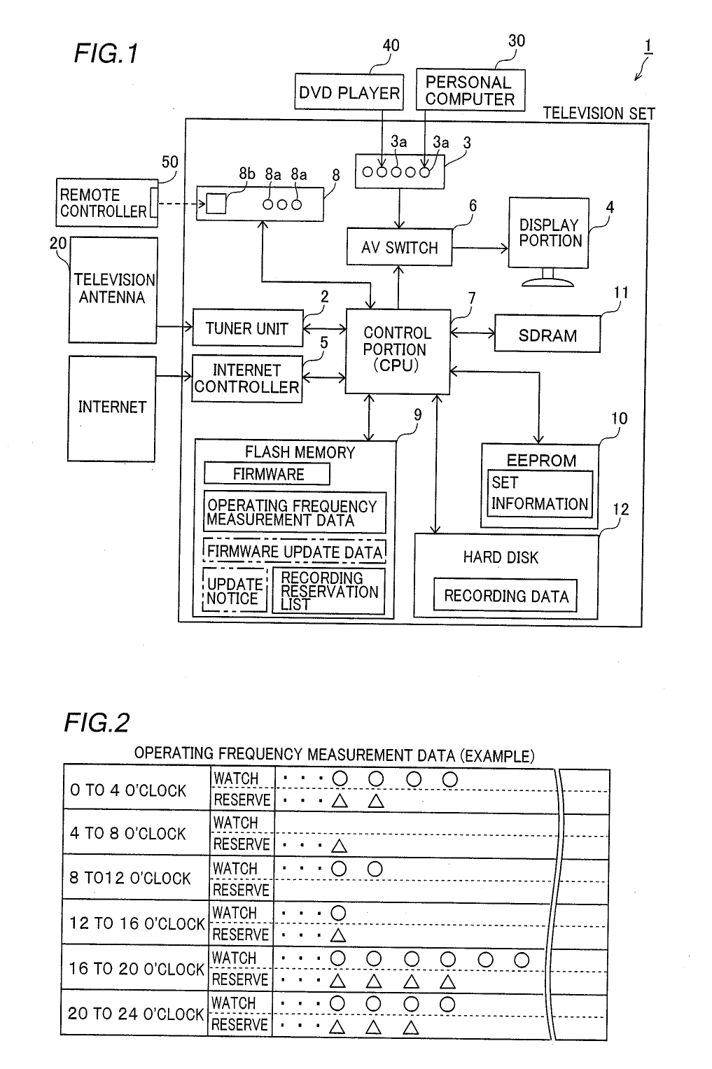

First, the structure of a television set 1 according to the embodiment of the present invention is described with reference to FIG. 1. This embodiment of the present invention is applied to the television set 1 employed as an exemplary receiver.

As shown in FIG. 1, the television set 1 comprises a tuner unit 2 receiving television signals corresponding to digital broadcasts through a television antenna 20, an external input substrate 3 including a plurality of terminals 3a connected with external apparatuses such as a personal computer 30 and a DVD player 40, a display portion 4 formed by an LCD (liquid crystal display), an Internet controller 5 for connecting the television set 1 to the Internet to be capable of bidirectional communication, an AV switch 6 selecting a specific signal from among a plurality of signals received through the tuner unit 2, the external input substrate 3 and the Internet controller 5 and outputting the same to the display portion 4, and a control portion (CPU) 7 controlling the respective portions of the television set 1. The tuner unit 2, the external input substrate 3 and the Internet controller 5 are examples of the “receiving portion” in the present invention.

The television set 1 further comprises an input portion 8 having a plurality of buttons 8a for changing the volume of the television set 1, a channel etc. and changing setting and the like, and the input portion 8 includes a receiving portion 8b receiving signals from a remote control 50. The aforementioned volume, the channel etc. can be changed also through the remote control 50. The signals received through the input portion 8 or from the remote control 50 are input in the control portion 7, which in turn controls the respective portions of the television set 1 to perform prescribed processing on the basis of the signals.

The tuner unit 2 is so formed as to detect television signals of channels watchable in a prescribed district and acquire information through an auto-preset function of the television set 1. The auto-preset function is a function of automatically setting watchable channels to a state where television signals thereof are receivable when the user simply selects the district where the television set 1 is set. The tuner unit 2 is further so formed as to receive a corresponding television broadcast and output a signal obtained as a result to the AV switch 6 through the control portion 7 on the basis of an instruction from the control portion 7 when the user specifies a channel.

The tuner unit 2 is so formed as to receive an update notice. This update notice, included in the television broadcast, is received along with television program information (EPG: electronic program guide) or the like, and the tuner unit 2 receives firmware update data for updating firmware to the latest version on the basis of the update notice. The update notice includes information on the date and time when the firmware update data is transmitted etc. After the tuner unit 2 receives the update notice, the control portion 7 controls a flash memory 9 to store this update notice. The flash memory 9 is an example of the “first storage portion” or the “second storage portion” in the present invention.

The display portion 4 is so formed as to display images based on the television broadcasts received through the AV switch 6 and the signals received from the external apparatuses and the Internet.

The control portion 7 so controls the AV switch 6 as to select a specific signal from among the plurality of signals received from the tuner unit 2, the external input substrate 3 and the Internet controller 5.

The control portion 7 is so formed as to control the television set 1 on the basis of set information stored in an EEPROM 10 and the firmware stored in the flash memory 9. The set information includes information on setting related to display on the display portion 4, for example. More specifically, the set information includes information on setting related to parental control, information on setting related to captions (subtitles), information on setting related to language etc. This set information is set in a state (initial state) corresponding to a standard mode of the television set 1 when the television set 1 is shipped from a factory. The firmware includes program data not only enabling the user to watch the images based on the television broadcasts and the signals received from the external apparatuses and the Internet but also for controlling the overall television set 1.

According to this embodiment, the control portion 7 is so formed as to store a watch history of the user watching the images based on the television broadcasts and the signals received from the external apparatuses and the Internet and a recording reservation history related to recording reservation for these images in the flash memory 9 as operating frequency measurement data. More specifically, the control portion 7 is so formed as to store the watch history and the recording reservation history as the operating frequency measurement data every time zone divided in units of 4 hours, as shown in FIG. 2. For example, the control portion 7 is so formed as to rewrite the operating frequency measurement data to add one watch history when the user watches images for at least 30 minutes while adding one recording reservation history when the user reserves recording. Thus, the flash memory 9 stores accumulative watch and recording reservation histories from the time of purchase of the television set 1 in the operating history of the television set 1 related to operations of the user. The control portion 7 adds reservation information to a recording reservation list stored in the flash memory 9 when the user reserves recording, and deletes the reservation information from the recording reservation list when the television set 1 completes the recording or the user cancels the recording reservation. Thus, the user can confirm the information on the current recording reservation in the television set 1 by referring to the recording reservation list.

The control portion 7 is so formed as to control the tuner unit 2 to receive the firmware update data on the basis of the aforementioned update notice and to control the flash memory 9 to store the received firmware update data. More specifically, the control portion 7 determines whether or not the version of the received firmware update data is later than the version of the firmware currently stored in the flash memory 9 and whether or not the received firmware update data is already stored in the flash memory 9 on the basis of the update notice. Thus, the control portion 7 can prevent the tuner unit 2 from repeatedly receiving the same firmware update data, to reliably receive the data of the latest version. Further, the control portion 7 is so formed as to determine whether or not the television set 1 is currently in a standby state. When determining that the received firmware update data is the latest data and not yet stored in the flash memory 9 and the television set 1 is in a standby state in the aforementioned three determinations, the control portion 7 controls the tuner unit 2 to start receiving the firmware update data. When the tuner unit 2 normally completely receives the firmware update data with no interruption, the control portion 7 controls the flash memory 9 to store the firmware update data. When the tuner unit 2 does not normally completely receive the firmware update data, on the other hand, the control portion 7 makes the aforementioned determinations again and controls the tuner unit 2 to receive the firmware update data upon subsequent transmission on the basis of the update notice. The “standby state” of the television set 1 denotes such a state that a main power source of the television set 1 is in an ON-state but portions other than a specific portion of the television set 1 are not yet started.

According to this embodiment, the control portion 7 is so formed as to update the firmware on the basis of the operating history, the current recording reservation situation and the operating situation of the television set 1 when the flash memory 9 stores the firmware update data. More specifically, the control portion 7 redetermines whether or not the firmware update data stored in the flash memory 9 is the latest data, and determines whether or not the current time is in the minimum operating frequency time zone on the basis of the operating history measurement data. The minimum operating frequency time zone denotes the time zone exhibiting the minimum sum of the watch history and the recording reservation history added to the operating frequency measurement data. In other words, the control portion 7 is so formed as to determine whether or not the current time is in the time zone when the user least frequently watches images or reserves recording. Thus, the control portion 7 can determine the time zone when there is the smallest possibility that the user uses the television set 1. Further, the control portion 7 determines whether or not recording is currently reserved on the basis of the recording reservation list, and determines whether or not the television set 1 is in a standby state. Thus, the control portion 7 can prevent the currently set recording reservation from erasing, and can determine that the user does not currently use the television set 1. The control portion 7 is so formed as to update the firmware when determining that the firmware update data is the latest data, the current time is in the minimum operating frequency time zone, no recording is reserved, and the television set 1 is n a standby state in the aforementioned four determinations. Further, the control portion 7 is so formed as to delete the firmware update data after completely updating the firmware.

An SDRAM 11 is a memory temporarily storing data when the control portion 7 performs an operation. A hard disk 12 is enabled to store recorded data and delete data stored by an operation of the user. The hard disk 12 is an example of the “third storage portion” in the present invention.

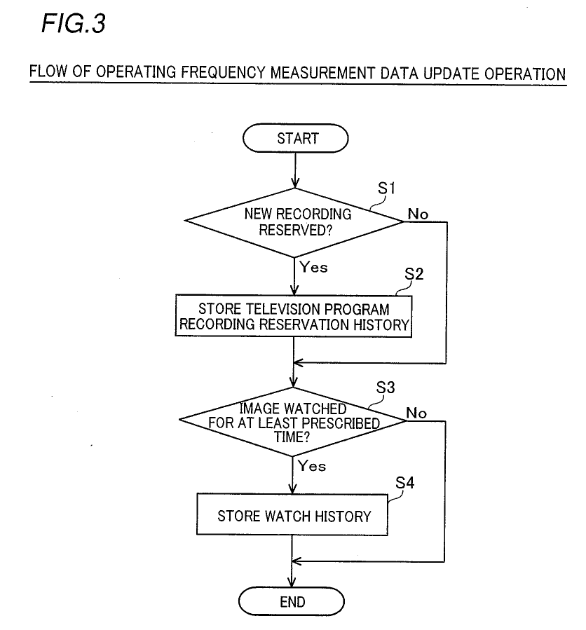

An operating frequency measurement data update operation of the television set 1 according to the embodiment of the present invention is now described with reference to FIG. 3.

First, the control portion 7 determines whether or not new recording is reserved at a step S1, rewrites the operating frequency measurement data to add one recording reservation history at a step S2 when determining that new recording is reserved, and advances to a step S3. When determining that no new recording is reserved, on the other hand, the control portion 7 advances to the step S3 without rewriting the operating frequency measurement data. The control portion 7 determines whether or not the user watches images for at least 30 minutes at the step S3, and rewrites the operating frequency measurement data to add one watch history at a step S4 and terminates the operation when determining that the user watches images for at least 30 minutes. When determining that the user does not watch images for at least 30 minutes, on the other hand, the control portion 7 terminates the operation without rewriting the operating frequency measurement data. The control portion 7 repeats the series of operations at any time while the television set 1 is started.

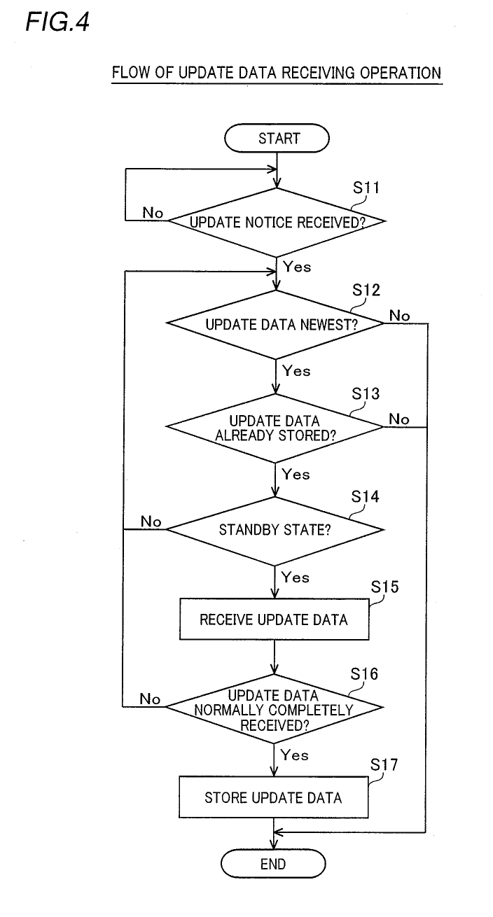

A firmware update data receiving operation of the television set 1 according to the embodiment of the present invention is described with reference to FIG. 4.

At a step S11, the control portion 7 determines whether or not an update notice is received, and repeats this determination when determining that the update notice is not received. When determining that the update notice is received, on the other hand, the control portion 7 determines whether or not the received firmware update data is the latest data having a version later than the version of the current firmware on the basis of the update notice stored in the flash memory 9 at a step S12, and terminates the operation when determining that the received firmware update data is not the latest data. When determining that the received firmware update data is the latest data, on the other hand, the control portion 7 determines whether or not the transmitted firmware update data is already stored in the flash memory 9 at a step S13. When determining that the transmitted firmware update data is already stored in the flash memory 9, the control portion 7 terminates the operation. When determining that the transmitted firmware update data is not yet stored in the flash memory 9, on the other hand, the control portion 7 determines whether or not the television set 1 is in a standby state at a step S14. The control portion 7 returns to the step S12 when determining that the television set 1 is not in a standby state. When determining that the television set 1 is in a standby state, on the other hand, the control portion 7 controls the tuner unit 2 to receive the firmware update data on the basis of the update notice at a step S15. At a step S16, the control portion 7 determines whether or not the tuner unit 2 normally completely receives the firmware update data, and returns to the step S12 when determining that the tuner unit 2 does not normally completely receive the firmware update data. When determining that the tuner unit 2 normally completely receives the firmware update data, on the other hand, the control portion 7 controls the flash memory 9 to store the received firmware update data at a step S17, and terminates the operation. The control portion 7 repeats the series of operations at any time while the television set 1 is started.

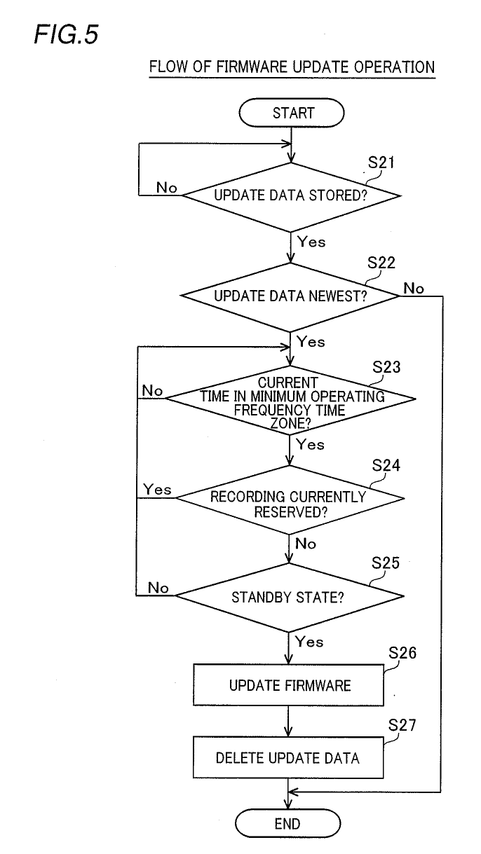

A firmware update operation of the television set 1 according to the embodiment of the present invention is described with reference to FIG. 5.

At a step S21, the control portion 7 determines whether or not the flash memory 9 stores the firmware update data, and repeats this determination when determining that the flash memory 9 does not store the firmware update data. When determining that the flash memory 9 stores the firmware update data, on the other hand, the control portion 7 redetermines whether or not the firmware update data is the latest data at a step S22, and terminates the operation if determining that the firmware update data is not the latest data. When determining that the firmware update data is the latest data, on the other hand, the control portion 7 determines whether or not the current time is in the minimum operating frequency time zone on the basis of the operating history measurement data at a step S23, and repeats this determination until the current time reaches the minimum operating frequency time zone if determining that the current time is not in the minimum operating frequency time zone. When determining that the current time is in the minimum operating frequency time zone, on the other hand, the control portion 7 determines whether or not recording is currently reserved at a step S24, and returns to the step S23 if determining that recording is currently reserved. When determining that no recording is currently reserved, on the other hand, the control portion 7 determines whether or not the television set 1 is in a standby state at a step S25, and returns to the step S23 when determining that the television set 1 is not in a standby state. When determining that the television set 1 is in a standby state, on the other hand, the control portion 7 updates the firmware at a step S26, deletes the firmware update data at a step S27, and terminates the operation.

According to this embodiment, as hereinabove described, the television set 1 is provided with the flash memory 9 storing the firmware and the operating history of the body of the television set 1 and the control portion 7 updating the firmware on the basis of the operating history stored in the flash memory 9 so that the control portion 7 can select the time when the user less frequently uses the television set 1 for updating the firmware in this period, thereby updating the firmware when there is a small possibility that the user uses the television set 1. Thus, the possibility that the user starts using the television set 1 after the control portion 7 starts updating the firmware can be reduced, thereby reducing the possibility of limiting an operation of the user and the possibility of stopping the operation of the control portion 7 updating the firmware in an intermediate stage due to the operation of the user. Consequently, the control portion 7 can update the firmware while hardly burdening the user.

According to this embodiment, the television set 1 is provided with the hard disk 12 recording television broadcasts and the operating history includes a television program recording reservation history so that the control portion 7 can select the time when the user less frequently uses the television set 1 for updating the firmware in this period on the basis of not only a television program watch history but also the television program recording reservation history, whereby the possibility that the user starts using the television set 1 after the control portion 7 starts updating the firmware can be reduced.

According to this embodiment, the control portion 7 is so formed as to update the firmware also on the basis of the current television program recording reservation situation along with the operating history to be capable of selecting the time when no recording is reserved for updating the firmware in this period, whereby the control portion 7 can prevent the currently set recording reservation from erasing resulting from the operation of updating the firmware.

According to this embodiment, the television set 1 is provided with the Internet controller 5 receiving signals from the Internet and the external input substrate 3 receiving signals from the external apparatuses such as the personal computer 30 and the DVD player 40 in addition to the tuner unit 2 receiving television broadcasts and the control portion 7 is so formed as to control the flash memory 9 to store an image watch history based on the signals received from the Internet and the external apparatuses in addition to the watch history of the television broadcasts so that the control portion 7 can update the firmware on the basis of the operating frequency measurement data including the image watch history based on the signals received from the Internet and the external apparatuses in addition to the watch history of the television broadcasts, whereby the possibility that the user starts using the television set 1 while the control portion 7 updates the firmware can be further reduced.

According to this embodiment, the control portion 7 is so formed as to add one watch history to the operating frequency measurement data when the user watches images for at least 30 minutes so that the control portion 7 can be prevented from adding an operation of the user watching images for an extremely short time for selecting the channel or the like, for example, to the operating frequency measurement data as the watch history, whereby the control portion 7 can write a watch history more conforming to the actual situation in the operating frequency measurement data.

Although the present invention has been described and illustrated in detail, it is clearly understood that the same is by way of illustration and example only and is not to be taken by way of limitation, the spirit and scope of the present invention being limited only by the terms of the appended claims.

For example, while the aforementioned embodiment is applied to the television set 1 employed as an exemplary receiver, the present invention is not restricted to this but is also applicable to a receiver other than the television set 1 so far as the receiver updates program data.

While the operating history includes the watch history and the recording reservation history in the aforementioned embodiment, the present invention is not restricted to this but the operating history may alternatively include an accumulative watch time of the user watching the television set 1, for example, so far as the operating history includes at least the watch history.

While the flash memory 9 stores the accumulative watch and recording reservation histories included in the operating frequency measurement data from the time of purchase of the television set 1 in the aforementioned embodiment, the present invention is not restricted to this but the flash memory 9 may alternatively initialize the histories every time the control portion 7 updates the firmware, for example. According to this structure, the operating frequency measurement data reflects the current situation of the user using the television set 1 when the situation of the user using the television set 1 varies with time, whereby the control portion 7 can more reliably determine the time zone when there is a small possibility that the user uses the television set 1.

While the control portion 7 stores the history every time zone divided in units of 4 hours in the aforementioned embodiment, the present invention is not restricted to this but the control portion 7 may alternatively store the history every time zone divided in units of 1 hour, for example.

What is claimed is:

1. A receiver comprising:
a receiving portion capable of receiving a television broadcast;
a first storage portion storing program data allowing the user to watch said television broadcast;
a second storage portion for storing an operating history of a receiver body including at least a television program watch history; and
a control portion controlling said receiver body on the basis of said program data and updating said program data on the basis of said operating history stored in said second storage portion.

2. The receiver according to claim 1, further comprising a third storage portion recording said television broadcast, wherein
said operating history further includes a television program recording reservation history.

3. The receiver according to claim 2, wherein
said control portion is so formed as to update said program data also on the basis of the current television program recording reservation situation along with said operating history.

4. The receiver according to claim 1, wherein
said control portion is so formed as to control said second storage portion to store said operating history every prescribed time zone.

5. The receiver according to claim 4, wherein
said operating history stored in said second storage portion includes an operating history in a first time zone and an operating history in a second time zone exhibiting a lower operating frequency than said first time zone, and
said control portion is so formed as to update said program data in said second time zone exhibiting a lower operating frequency than said first time zone.

6. The receiver according to claim 5, wherein
said control portion is so formed as to update said program data when said operating frequency is at the lowest level on the basis of said operating history.

7. The receiver according to claim 5, wherein
said control portion is so formed as to control said receiving portion to receive update data for updating said program data in said second time zone exhibiting a lower operating frequency than said first time zone.

8. The receiver according to claim 4, wherein
said prescribed time zone is divided at a regular interval.

9. The receiver according to claim 1, wherein
said receiving portion is enabled to receive at least either a signal from the Internet or a signal from an external apparatus in addition to a television broadcast signal, and
said control portion is so formed as to control said second storage portion to store said operating history of said receiver body including an image watch history based on at least said signal from the Internet or said signal from said external apparatus.

10. The receiver according to claim 1, wherein
said control portion is so formed as to control said second storage portion to store said operating history of said receiver body as said television program watch history when the user watches a television program for at least a prescribed time.

11. The receiver according to claim 1, wherein
said control portion is so formed as to determine whether or not said receiver body is in a standby state for updating said program data on the basis of said operating history when determining that said receiver body is in said standby state.

12. The receiver according to claim 1, wherein
said television program watch history is an accumulative watch history from the time of purchase of said receiver.

12. The receiver according to claim 1, wherein
said receiver is a television set.
